(19) United States
(12) Patent Application Publication
(10) Pub. No.: US 2026/0365931 A1
(43) Pub. Date: Nov. 19, 2026

(54) HEAT INTEGRATION UTILIZING INTERMEDIARY FLUID IN GASIFICATION

(71) Applicant: SunGas Renewables, Inc., Houston, TX (US)

(72) Inventors: Terry HUGHES, Jersey Village, TX (US); Sekar DARUJATI, Houston, TX (US)

(21) Appl. No.: 19/155,744

(22) PCT Filed: Feb. 12, 2024
(86) PCT No.: PCT/US24/15344

§ 371 Date: Aug. 12, 2025

Related U.S. Application Data
(60) Provisional application No. 63/445,839, filed on Feb. 15, 2023.

(51) Int. Cl. C10J 3/86; B01D 53/14; C01B 3/323

(52) U.S. Cl. CPC C10J 3/86; B01D 53/1456; C01B 3/323; B01D 2257/2045; B01D 2257/406; B01D 2257/408; C01B 2203/0283; C10J 2300/1684; C10J 2300/1861; C10J 2300/1884

(57) ABSTRACT

Gasification processes utilizing carbonaceous feeds and preferably biomass are disclosed, which can effectively integrate heat between at least two unit operations, through the use of an intermediary fluid. This advantageously improves operating flexibility, in terms of meeting an array of potentially mis-matched boundary conditions associated with the unit operations to/from which heat is transferred, including flows, temperatures, and pressures. Divergent interfacing requirements are thereby addressed, and the use of a non-toxic intermediary fluid for heat exchange ensures environmental safety in the event that such fluid is leaked. In representative embodiments, configurations whereby heat may be added to, or rejected from, the intermediary fluid, such as in the case of its circulation in an open or closed loop, can further support interface requirements between any two operations, or among several operations.

### CROSS REFERENCE TO RELATED APPLICATIONS

This application claims the benefit of priority to U.S. Provisional Application No. 63/445,839, filed Feb. 15, 2023, which is hereby incorporated by reference in its entirety.

### FIELD OF THE INVENTION

Aspects of the invention relate to gasification processes, and more particularly heat integration between unit operations in such processes, utilizing an intermediary fluid, such as a water-based fluid, an oil-based fluid, or a glycol-based fluid.

### DESCRIPTION OF RELATED ART

The gasification of coal has been performed industrially for over a century in the production of synthesis gas (syngas) that can be further processed into transportation fuels. More recent efforts toward developing energy independence with reduced greenhouse gas emissions have led to a strong interest in using biomass as a gasification feed, and thereby an alternative potential source of synthesis gas, as well as its downstream conversion products. Generally, biomass gasification is performed by partial oxidation in the presence of a suitable oxidizing gas containing oxygen and other possible components such as steam. Gasification at elevated temperature and pressure, optionally in the presence of a catalytic material, produces an effluent with hydrogen and oxides of carbon (CO, CO₂), as well as hydrocarbons such as methane. This effluent, which is often referred to as synthesis gas in view of its H₂ and CO content, must be cooled significantly and also treated to remove a number of undesired components that can include particulates, alkali metals, halides, and sulfur compounds, in addition to byproducts of gasification that are generally referred to as tars and oils. Furthermore, downstream conversion of the synthesis gas to value-added products often requires its hydrogen content to be increased, relative to that obtained from gasification alone.

Increasing the H₂:CO molar ratio of the synthesis gas for its subsequent use in a number of reactions can be carried out by performing the exothermic water-gas shift (WGS) reaction gas, according to:

CO+H₂O↔H₂+CO₂.

The thermodynamics of this reaction govern an equilibrium shift toward hydrogen production at lower temperatures, which are generally unfavorable from the standpoint of reaction kinetics. Operations conducted to purify the gasifier effluent, or synthesis gas, in preparation for the catalytic WGS reaction, include filtration for the removal of solid particles and scrubbing to remove water-soluble contaminants. These operations require significant reductions in temperature, relative to those used in the upstream gasification and tar removal operations. Overall, the economics of biomass gasification and the effective utilization of the produced synthesis gas for obtaining desired end products are impacted by a number of complex and interacting processing objectives, as well as the associated equipment requirements. In this regard, the effective regulation of vastly differing heat requirements among unit operations, some of which generate heat and others of which consume heat, remains an ongoing challenge.

Efforts to recover valuable heat from the high-temperature syngas produced from upstream gasification and tar removal, while achieving an acceptable degree of cooling for downstream filtration/scrubbing, together with heat utilization for upstream feed drying, have led to various heat integration strategies. These are often complicated, as a practical matter, by interdependencies between processing equipment used for heating/cooling objectives that are not necessarily aligned and even widely unbalanced. For example, in the case of using biomass hot water loops to provide scrubber cooling, the heat exchange between large quantities of circulating hot water for biomass drying and water being fed to the scrubber can introduce processing variables that are not easily managed. More generally, heat integration between unit operations is typically inefficient. As a practical matter, a biomass conversion to syngas facility, for carrying out processes as described herein, may be placed on a site with a biomass drying technology, which can utilize heat energy generated from biomass conversion facility. Nonetheless, the interfaces between the two technologies may be mis-matched in one or more of several respects. Adaptions to one or both technologies to address this issue can result in additional engineering, schedule delays, increased operational complexity, and higher costs.

Overall, the present state of the art would benefit from improvements in gasification technology, relating to managing the significant heat production and consumption characteristics of process unit operations.

### SUMMARY OF THE INVENTION

Aspects of the invention are associated with the discovery of gasification processes utilizing carbonaceous feeds and preferably biomass, which can implement one or more strategies for effective heat integration between at least two unit operations, through the use of an intermediary fluid. This advantageously improves the “flexibility” of such integration, in terms of meeting an array of potentially mis-matched boundary conditions associated with the unit operations to/from which heat is transferred, including flows, temperatures, and pressures. Divergent interfacing requirements are thereby addressed, and, in representative embodiments, the use of a non-toxic intermediary fluid for heat exchange ensures environmental safety in the event that such fluid is leaked. According to particular configurations whereby heat may be added to, or rejected from, the intermediary fluid, such as in the case of its circulation in an open or closed loop, interface requirements between any two operations, or among several operations, are further supported.

Particular aspects relate to overcoming problems associated with conventional heat exchange loops utilizing fluid obtained elsewhere in (e.g., internal to) the process. For example, process water, for transferring heat to or from an operation, can cross-contaminate that operation in the event of a leak, thereby introducing unsafe and/or corrosive constituents by physical material transfer of this process water, despite the intention to perform solely heat transfer. In this regard, process water of a scrubbing operation, through its normal use in contacting syngas obtained from gasification, generally receives one or more of CO, CO₂, N₂, NH₃, HCl, HCN, CH₄ contaminants that the scrubbing operation is configured to remove from the inlet gas stream. The use of an intermediary fluid, devoid of these constituents, dramatically reduces the probability of such cross-contamination, which would effectively require a “double jeopardy” event, such as simultaneous exchanger leaks causing material flow from contaminated process water into a second operation configured to accept or reject heat from that stream.

Another drawback of direct heat exchange with a fluid from the process, such as process water, is that this can require a downstream unit operation to utilize pressures exceeding that of the process fluid, in order to hinder or prevent cross-contamination as noted above. Such pressures will generally be counter to promoting the overall flow of syngas from the gasifier effluent to the WGS operation and any subsequent operations, and may also be less than ideal for performing the downstream operation for which heat-exchanging contact with the process water is required. Increased pressure specifications typically result in added costs of this interfacing operation and/or may create a disconnect (incompatibility) between interfaces of two heat-exchanging operations. This problem can be addressed by shifting the pressure limitations from the process itself to the intermediary fluid, particularly in the case of its pressure being variable or adjustable to meet a given heat transfer application.

Yet another issue addressed by the use of an intermediary fluid is incompatible flow rates. In this regard, heat exchange often requires a minimum flow or circulation rate to remove or accept a defined amount of heat energy (e.g., for temperature control), which rate may or may not align with the interfacing operation. For example, a scrubber inlet maximum temperature specification may be associated with a minimum process water flow or circulation rate through a heat exchanger (e.g., boiler) to prevent this maximum temperature from being exceeded. At this minimum rate, the steam generated may provide more or less heat than demanded from an interfacing operation with completely independent heating requirements. In either case, an incompatible interface between operations arises. This constraint is alleviated, however, by the capability of an intermediary fluid to provide some “buffering” capacity, in the sense of serving as a heat sink for rejecting heat above interface requirements or a heat source for adding heat to satisfy these requirements. This capability is established, in exemplary embodiments, in conjunction with a circulation loop of the intermediary fluid, to which heat can be added or from which heat can be removed, as needed for interface compatibility.

Particular embodiments of the invention are directed to processes for gasification of a carbonaceous feed that utilize multiple operations including a first operation and a second operation, with such operations often having different heat output/generation and heat input/consumption characteristics. Representative processes comprise: (a) recovering a first amount of heat from the first operation of the process into a hot fluid, such that the hot fluid contains the recovered, first amount of heat; and (b) transferring a second amount of heat, which may be all or a portion of the first amount of heat, from the hot fluid to an intermediary fluid, which then provides a heated intermediary fluid. That is, the heated intermediary fluid contains the transferred, second amount of heat, for implementation elsewhere in the process. Such processes may further comprise (c) utilizing or consuming at least a portion of this second amount of heat, transferred in step (b) to the intermediary fluid, in the second operation. This may be achieved, for example, by providing or feeding the heated intermediary fluid to a heat input of the second operation (e.g., a heat exchanger directly or immediately upstream of the second operation). In this manner, utilizing heat from the heated intermediary fluid reduces the temperature of this fluid.

Other particular embodiments are directed to processes for gasification of a carbonaceous feed, which processes comprise various steps associated with corresponding operations. Representative processes comprise: in a gasifier, contacting the carbonaceous feed with an oxygen-containing gasifier feed, under gasification conditions, to provide a gasifier effluent comprising H₂, CO, CO₂, and H₂O; in a radiant syngas cooler (RSC) or convective syngas cooler (CSC), cooling the gasifier effluent; optionally further cooling the gasifier effluent in a scrubber feed cooler; in a scrubbing operation, scrubbing the gasifier effluent to remove water-soluble contaminants; optionally heating the gasifier effluent in a WGS feed heater; and, in a water-gas shift (WGS) operation, contacting the gasifier effluent with a WGS catalyst to increase its H₂:CO molar ratio, as provided in a WGS product of this operation. The H₂:CO molar ratio of the WGS product may be greater than that of the gasifier effluent elsewhere in the process, upstream of the WGS operation, such as upstream of the scrubber, and/or upstream of the RSC or CSC. According to such processes, heat recovered from a first operation into a hot fluid is utilized in a second operation of the process, by transfer of this recovered heat (from the first operation to the second operation) through an intermediary fluid.

In more specific embodiments, for example, the hot fluid may be one of (i) RSC-generated steam, in which heat is recovered from the RSC as the first operation of the process, (ii) CSC-generated steam, in which heat is recovered from the CSC as the first operation of the process, and (iii) scrubber-generated steam produced in the scrubber feed cooler, and in which heat is recovered from the scrubber, such as from a scrubber feed cooler immediately upstream of the scrubber, as the first operation of the process. Alternatively or in combination, the second operation may be one of (i) a dryer for drying of the carbonaceous feed and (ii) the WGS operation, including a WGS feed heater immediately upstream of this operation. For example, the heat transfer of recovered heat, as noted above, may be performed through the intermediary fluid being provided to a heat input of the dryer, or to a heat input of the WGS operation, such as via the WGS feed heater (or WGS feed heat exchanger).

A number of advantages may be realized from these aspects and embodiments of the invention, as well as others. Regardless of the particular manner in which the intermediary fluid is implemented, such as in a “once-through” or circulation loop configuration, direct heat exchange with process fluids that may leak toxic or environmentally detrimental constituents is avoided. This can result in reduced heat exchanger costs and maintenance (e.g., cleaning) requirements, thereby improving operability, such as by reducing downtime. Representative intermediary fluids may comprise or consist of, for example, water or aqueous solutions, hydrocarbons such as oils, glycol solutions (e.g., mixtures of water and polyethylene glycol or water and polypropylene glycol), and other liquids that may have low toxicity and/or environmental impact. Moreover, temperatures, pressures, and flow rates of the intermediary fluid can be varied independently of one another, and also independently of these conditions existing within the gasification process and its specific operations, to meet heating and cooling requirements in a flexible manner. For example, temperature may be controlled independently of pressure and/or flow rate via heat exchange of the intermediary fluid (e.g., circulating in a loop) with process steam and/or external steam. Flow rate, such as the circulation flow, may be controlled according to embodiments described and/or illustrated herein or according to other control loop configurations such as those utilizing variable frequency drives or control valves in alternate configurations of piping and flow elements. Flow rate of the intermediary fluid may be controlled independently of its temperature and/or pressure. Pressure may be controlled, independently of temperature and/or flow rate, through the use of header pressure, such as by blanketing a reservoir vessel with nitrogen or other inert gas.

Overall, integration between two operations, or among several operations, such as heat integration between biomass gasification operations and biomass drying operations, can advantageously be simplified and achieved with improved flexibility, through the use of an intermediary fluid. Regardless of the particular operations, or process in general, heat recovery and utilization may be easily regulated through a circulation loop of intermediary fluid, to which secondary or further loops may be adapted for additional integration with process heating or cooling and/or external heating or cooling. The use of such loop allows for the intermediary fluid to accept heat (e.g., from steam) at multiple (e.g., two or more) locations, such that a greater amount of heat can be supplied to meet higher heat demands, for example when increased quantities of biomass are dried during “catchup.” One or more circulation loops may be operated with heat input(s) and/or heat output(s) to operations independent of and/or external to, the process and/or facility for gasification of carbonaceous feed (e.g., biomass). According to one example, auxiliary steam may be employed for transferring heat energy to the intermediary fluid. This fluid and its corresponding energy content can be fed to and utilized in an operation benefitting from heat input, such as biomass drying to establish a dry biomass inventory prior to startup of a process as described herein.

These and other embodiments, aspects, and advantages relating to the present invention are apparent from the following Detailed Description.

### BRIEF DESCRIPTION OF THE DRAWING

A more complete understanding of the exemplary embodiments of the present invention and the advantages thereof may be acquired by referring to the following description in conjunction with the accompanying figures.

FIG. 1 depicts a flowscheme illustrating the use of an intermediary fluid for transferring heat from a first operation to a second operation.

FIG. 2 depicts a flowscheme illustrating an embodiment of a process for the gasification of a carbonaceous feed, which process employs various operations, including certain operations from which heat may be recovered, or in which heat may be utilized.

For the sake of simplicity, multiple features are illustrated and described in the figures, with the understanding that not all features (e.g., not all individual operations and their associated process streams and equipment) are required and that various specific features, such as the specific operations shown, can be implemented independently of one another, while nonetheless benefitting from heat transfer through an intermediary fluid, according to embodiments within the scope of the present invention.

In order to facilitate explanation and understanding, the figures provide an overview of methods for implementation in gasification processes according to various aspects of the invention. Some associated equipment such as certain vessels, heat exchangers, valves, instrumentation, and utilities, are not shown, as their specific description is not essential to the implementation or understanding of these aspects. Such equipment would be readily apparent to those skilled in the art, having knowledge of the present disclosure. Other processes for producing syngas and/or its conversion products such as renewable liquids, according to other embodiments within the scope of the invention and having configurations and constituents determined, in part, according to particular processing objectives, would likewise be apparent.

### DETAILED DESCRIPTION

The expressions “wt-%” and “mol-%,” are used herein to designate weight percentages and molar percentages, respectively. The expressions “wt-ppm” and “mol-ppm” designate weight and molar parts per million, respectively. For ideal gases, “mol-%” and “mol-ppm” are equal to percentages by volume and parts per million by volume, respectively. The terms “barg” and “psig” are used herein to designate gauge pressures (i.e., pressure in excess of atmospheric pressure) in units of bars and pounds per square inch, respectively, whereas the terms “bar” and “psi” are used herein to designate absolute pressures. For example, gauge pressures of 0 barg and 0 psig are approximately equivalent to absolute pressures of 1 bar and 14.5 psi, respectively.

The term “substantially,” as used herein, refers to an extent of at least 95%. For example, the phrase “substantially all” may be replaced by “at least 95%.” The phrases “all or a portion” or “at least a portion” are meant to encompass, in certain embodiments, “at least 50% of,” “at least 75% of,” “at least 90% of,” and, in preferred embodiments, “all.” Likewise, designated portions, such as a “first portion” or “second portion” may represent these percentages (but not all) of the total, and particularly these percentages (but not all) of the total process stream to which they refer.

Reference to any operation of a gasification process, from which heat may be recovered and/or in which transferred heat may be utilized, includes any heat exchanger(s) associated with (e.g., directly upstream of and/or directly downstream of) such operation, namely heaters having a heat input to which an intermediary fluid, and consequently heat from this fluid, can be added to the operation, and coolers from which a hot fluid, and consequently heat from this fluid, can be recovered from the operation. Therefore, for example, a scrubber operation includes a scrubber feed cooler directly upstream of this operation, and a water-gas shift (WGS) operation includes a WGS feed heater directly upstream of this operation.

Reference to any starting material, intermediate product, final product, or intermediary fluid which are all preferably process streams in the case of continuous processes, should be understood to mean “all or a portion” of such starting material, intermediate product, final product, or intermediary fluid, in view of the possibility that some portions may not be used, such as due to sampling, purging, diversion for other purposes, mechanical losses, etc. Therefore, for example, the phrase “providing or feeding the heated intermediary fluid to a heat input of the second operation” should be understood to mean “providing or feeding all or a portion of the heated intermediary fluid to a heat input of the second operation.” As in the case of “all or portion” being expressly stated, when “all or a portion” is the understood meaning, this phrase is should further be understood to encompasses certain and preferred embodiments as noted above.

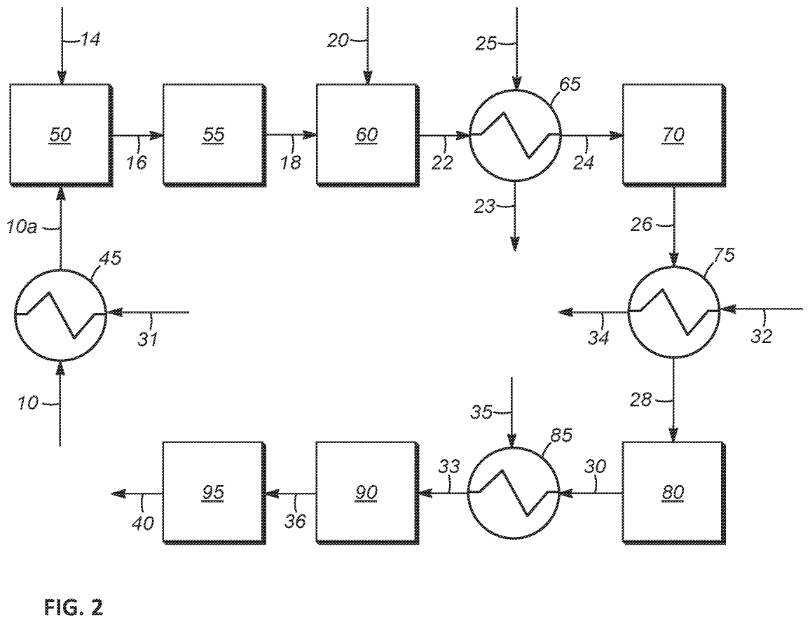

Representative processes described herein for the gasification of a carbonaceous feed may comprise a number of unit operations, with one of such operations stated as being performed or carried out “before,” “prior to,” or “upstream of” another of such operations, or with one of such operations being performed or carried out “after,” “subsequent to,” or “downstream of,” another of such operations. These quoted phrases, which refer to the order in which one operation is performed or carried out relative to another, are in reference to the overall process flow, as would be appreciated by one skilled in the art having knowledge of the present specification. More specifically, the overall process flow can be defined by the bulk gasifier effluent flow, including bulk flows of both the un-scrubbed gasifier effluent and scrubbed gasifier effluent, as well as the bulk WGS product flow, as such flow(s) is/are subjected to operations as defined herein. Insofar as the quoted phrases are used to designate order, in specific embodiments these phrases mean that one operation immediately precedes or follows another operation, whereas more generally these phrases do not preclude the possibility of intervening operations. Therefore, for example, one or more “operations downstream of the gasifier” can refer, according to a specific embodiment, an operation that immediately follows the gasifier, such as in the case of a tar removal operation according to the embodiment illustrated in FIG. 2. However, this phrase more generally, and preferably, refers to any of, or any combination of, operations that follow the gasifier, whether or not intervening operations are present, such as in the case of any one or more of a quenching operation, a radiant syngas cooler (RSC) or convective syngas cooler (CSC), and/or a filtration operation that follow the tar removal operation, as an intervening operation, according to the embodiment illustrated in FIG. 2. Therefore, to the extent that representative processes described herein are defined as including certain unit operations, unless otherwise stated or designated (e.g., by using the phrase “consisting of”), such processes do not preclude the use of other operations, whether or not specifically described herein.

Specific processes described herein are defined by a gasifier, an RSC or a CSC, a scrubbing operation (e.g., wet scrubber) downstream of the gasifier, and a WGS operation downstream of the scrubbing operation. The gasifier provides a “gasifier effluent” and the WGS operation provides a “WGS product.” The term “gasifier effluent” is a general term that refers to the effluent of the gasifier, whether or not having been subjected to one or more operations downstream of the gasifier and upstream of the WGS operation. The “gasifier effluent” may be more particularly designated, for example, as an “un-scrubbed gasifier effluent” or a “scrubbed gasifier effluent,” which are also general terms but add specificity in terms of characterizing the gasifier effluent depending on whether or not it has been subjected to the scrubbing operation.

The terms “gasifier effluent” and “un-scrubbed gasifier effluent” encompass more specific terms that designate (i) the effluent provided directly by the gasifier, i.e., the “raw gasifier effluent,” (ii) the raw gasifier effluent having been subjected to at least a tar removal operation, i.e., a “tar-depleted gasifier effluent,” having a lower concentration of tars and oils relative to the raw gasifier effluent, (iii) the raw gasifier effluent having been subjected to at least a dry quenching operation, i.e., a “quenched gasifier effluent,” having a lower temperature and higher moisture (H₂O) concentration relative to the raw gasifier effluent, resulting from direct quenching (e.g., partial quenching) with water, (iv) the raw gasifier effluent having been subjected to at least a radiant syngas cooler (RSC) or at least a convective syngas cooler (CSC), i.e., a “cooled gasifier effluent” having a lower temperature relative to the raw gasifier effluent, resulting from heat transfer for external steam generation, (v) the raw gasifier effluent having been subjected to at least a filtration operation, i.e., a “filtered gasifier effluent,” having a lower solid particle content relative to the raw gasifier effluent, and which may provide all or part of a “heated scrubber feed,” (vi) the raw gasifier effluent having been subjected to further removal of heat (cooling), and which may provide all or part of a “scrubber feed,” having a lower temperature relative to the raw gasifier effluent, resulting from further heat removal (e.g., to generate steam), and (vii) the raw gasifier effluent having been subjected to any other operation upstream of the scrubbing operation, whether or not specifically described herein.

Likewise, the terms “gasifier effluent” and “scrubbed gasifier effluent” encompass more specific terms that designate (viii) the raw gasifier effluent or un-scrubbed gasifier effluent having been subjected to a scrubbing operation to reduce its content of water-soluble contaminants (e.g., chlorides), and (ix) the raw gasifier effluent having been subjected to input of heat (heating) upstream of the WGS operation, and which may provide all or part of a “WGS feed,” having a higher temperature relative to scrubbed gasifier effluent immediately upstream of this heat input resulting from heat exchange (e.g., with steam, such as that generated elsewhere in the process, which may be in the RSC or CSC) (x) the raw gasifier effluent having been subjected to any other operation downstream of the scrubbing operation, whether or not specifically described herein. The terms “gasifier effluent,” “un-scrubbed gasifier effluent,” and “scrubbed gasifier effluent,” and any of the more specific examples (i)-(x) of these terms, encompass products (e.g., flow streams) that are upstream of, and optionally may be fed to, the WGS operation that may be used to increase the H₂:CO molar ratio of the feed to this operation (e.g., of the scrubbed gasifier effluent, optionally having been heated as described above).

The term “WGS product” is a general term that refers to a product of the WGS operation, all or a portion of which may, according to particular embodiments, be fed to a syngas conversion operation or a syngas separation operation to provide as a value-added product, a renewable syngas conversion product or a renewable syngas separation product. The term “WGS product” encompasses all or a portion of the product provided directly by the WGS operation, or otherwise such product after having been subjected to heating, cooling, pressurization, depressurization, and/or purification, such as acid gas removal. The term “syngas,” or alternatively “synthesis gas product,” insofar as they relate to streams comprising H₂ and CO, are used herein to generally refer to the gasifier effluent, whether an un-scrubbed gasifier effluent or a scrubbed gasifier effluent as defined above, or the WGS product.

Particular examples of renewable syngas conversion products and renewable syngas separation products include both renewable liquid products (e.g., liquid hydrocarbons or methanol) and renewable gaseous products (e.g., renewable natural gas (RNG) or renewable hydrogen). The modifiers “syngas conversion” and “syngas separation,” as used in the terms “renewable syngas conversion product,” and “renewable syngas separation product,” are meant to more specifically designate the origin of these products, as being obtained from either a syngas conversion operation (e.g., comprising a Fischer-Tropsch reaction stage, a methanol synthesis reaction stage, or a methanation reaction stage) or a syngas separation operation (e.g., comprising a hydrogen purification stage, such as in the case of syngas separation by pressure swing adsorption (PSA) and/or the use of a membrane). Any such syngas conversion operation or syngas separation operation is preferably performed on the WGS product that can yield an increased, and more favorable, H₂:CO molar ratio, in terms of efficiently performing the desired conversion or separation. The use of the modifiers “separation” and “conversion” in the terms noted above to modify products does not preclude such products being obtained from a combination of separation and conversion.

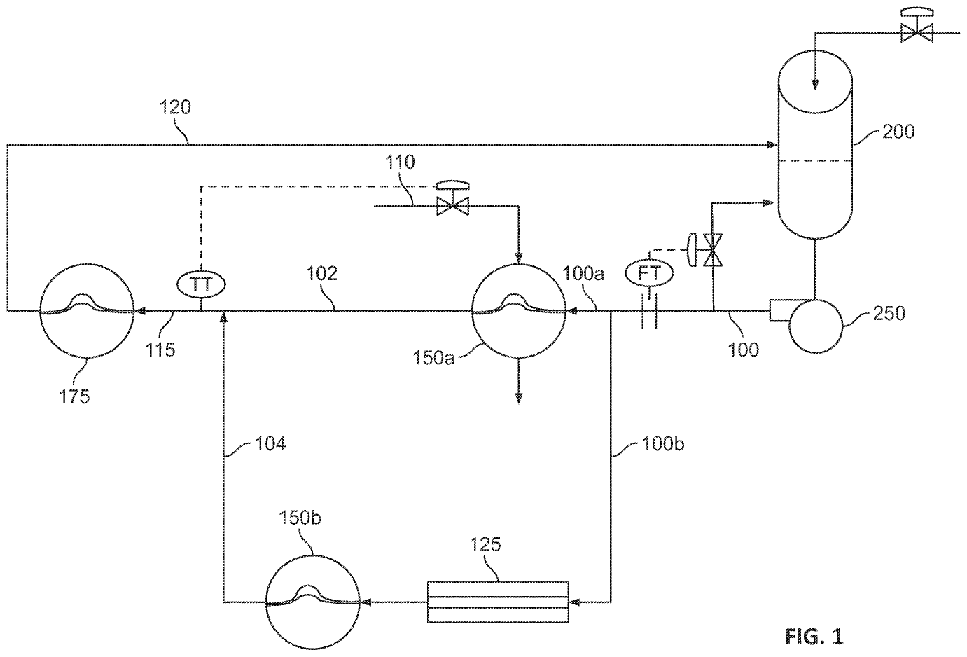

Representative gasification processes described herein are defined by various possible operations, occurring downstream of the gasifier which may include a tar removal operation; operations for cooling, such as a quenching operation, an RSC and/or a CSC; a filtration operation; a scrubber feed cooler (e.g., a boiler), which may provide steam generation for cooling; a scrubbing operation; a WGS feed heater, to which generated steam may be input for heating; a WGS operation; and a syngas conversion operation or syngas separation operation. Certain possible features of the gasifier, as well as certain of these downstream operations and their associated process streams and conditions, according to preferred embodiments and otherwise any embodiments as defined in the claims, as well as the embodiments illustrated in FIGS. 1 and 2, are provided in the following description.

### Gasifier

Representative processes comprise, in a gasifier, contacting a carbonaceous feed with an oxygen-containing gasifier feed, under gasification conditions, to provide a gasifier effluent (e.g., a raw gasifier effluent) comprising synthesis gas.

The carbonaceous feed may comprise coal (e.g., high quality anthracite or bituminous coal, or lesser quality subbituminous, lignite, or peat), petroleum coke, asphaltene, and/or liquid petroleum residue, or other fossil-derived substance. In a preferred embodiment, the carbonaceous feed may comprise biomass. The term “biomass” refers to renewable (non-fossil-derived) substances derived from organisms living above the earth's surface or within the earth's oceans, rivers, and/or lakes. Representative biomass can include any plant material, or mixture of plant materials, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, and sugar cane bagasse, in addition to “on-purpose” energy crops such as switchgrass, miscanthus, and algae. Short rotation forestry products, such as energy crops, include alder, ash, southern beech, birch, eucalyptus, poplar, willow, paper mulberry, Australian Blackwood, sycamore, and varieties of paulownia elongate. Other examples of suitable biomass include vegetable oils, carbohydrates (e.g., sugars), organic waste materials, such as waste paper, construction, demolition wastes, digester sludge, and biosludge. Representative carbonaceous feeds therefore include, or comprise, any of these types of biomass. Particular carbonaceous feeds comprising biomass include municipal solid waste (MSW) or products derived from MSW, such as refuse derived fuel (RDF). Carbonaceous feeds may comprise a combination of fossil-derived and renewable substances, including those described above. A preferred carbonaceous feed is biomass and particularly wood (e.g., in the form of wood chips).

In the gasifier (or, more particularly, a gasification reactor of this gasifier), the carbonaceous feed is subjected to partial oxidation in the presence of an oxygen-containing gasifier feed, added in an amount generally limited to supply only 20-70% of the oxygen that would be necessary for complete combustion. The oxygen-containing gasifier feed will generally comprise other oxygenated gaseous components including H₂O and/or CO₂ that may likewise serve as oxidants of the carbonaceous feed. The oxygen-containing gasifier feed can refer to all gases being fed or added to the gasifier, or otherwise can refer to gas that is separate from other gases being fed or added, whether subsequently combined upstream of, or within, the gasifier. For example, the oxygen-containing gasifier feed may be introduced to the gasifier, along with steam, or a portion of steam, generated elsewhere in the process (e.g., RSC-generated steam) and used as a separate feed. Contacting of the carbonaceous feed with the oxygen-containing gasifier feed in the gasifier provides a gasifier effluent, and more particularly a raw gasifier effluent as the product directly exiting the gasifier. One or more reactors (e.g., in series or parallel) of the gasifier may operate under gasification conditions present in such reactor(s), with these conditions including a temperature of generally from about 500 °C (932 °F) to about 1000°C (1832 °F), and typically from about 816 °C (1500 °F) to about 1038 °C (1900 °F). Other gasification conditions may include atmospheric pressure or elevated pressure, for example an absolute pressure generally from about 0.1 megapascals (MPa) (14.5 psi) to about 10 MPa (1450 psi), and typically from about 1 MPa (145 psi) to about 3 MPa (435 psi), or from about 0.5 MPa (72 psi) to about 2 MPa (290 psi).

Gasification reactor configurations include counter-current fixed bed (“up draft”), co-current fixed bed (“down draft”), and entrained flow plasma. Different solid catalysts, having differing activities for one or more desired functions in gasification, such as tar reduction, enhanced H₂ yield, and/or reduced CO₂ yield, may be used. Limestone may be added to a gasification reactor, for example, to promote tar reduction by cracking. Various catalytic materials may be used in a gasification reactor, including solid particles of dolomite, supported nickel, alkali metals, and alkali metal compounds such as alkali metal carbonates, bicarbonates, and hydroxides. Often, a gasifier is operated with a gasification reactor having a fluidized bed of particles of the carbonaceous feed (and optionally particles of solid catalyst), with the oxygen-containing gasifier feed, and optionally separate, fluidizing H₂O-and/or CO₂-containing feeds, being fed upwardly through the particle bed. Exemplary types of fluidized beds include bubbling fluidized beds and entrained fluidized beds.

In addition to gasifier effluent tar, the raw gasifier effluent comprises CO, CO₂, and methane (CH₄) that are derived from the carbon present in the carbonaceous feed, as well as H₂ and/or H₂O, and generally both, together with other components in minor concentrations, as described below. According to the embodiment illustrated in FIG. 2, the raw gasifier effluent 16 may be obtained directly from gasifier 50, prior to further operations as described herein.

The raw gasifier effluent, or any gasifier effluent having been subjected to one or more operations as described herein, may comprise synthesis gas, i.e., may comprise both H₂ and CO, with these components being present in various amounts (concentrations), and preferably in a combined amount of greater than about 25 mol-% (e.g., from about 25 mol-% to about 95 mol-%), greater than about 50 mol-% (e.g., from about 50 mol-% to about 90 mol-%), or greater than about 65 mol-% (e.g., from about 65 mol-% to about 85 mol-%). With respect to any such combined amounts (concentrations), the H₂:CO molar ratio of the gasifier effluent may be suitable for use in downstream syngas conversion operations or syngas separation operations, such as (i) the conversion to a renewable syngas conversion product comprising higher molecular weight hydrocarbons and/or alcohols of varying carbon numbers via Fischer-Tropsch conversion or (ii) the conversion to a renewable syngas conversion product comprising methanol via a catalytic methanol synthesis reaction, or (iii) the conversion to a renewable syngas conversion product comprising renewable natural gas (RNG) via catalytic methanation that increases the methane content in a resulting RNG stream, or (iv) the separation of a renewable syngas separation product comprising purified hydrogen. More typically, however, a WGS operation is needed to achieve a favorable H₂:CO molar ratio, and/or a favorable H₂ concentration, for these or other downstream syngas conversion and separation operations. For example, the WGS operation may include parameters (e.g., reactor temperatures and/or catalyst types) for obtaining the highest yield/concentration of hydrogen, through consumption of CO present in the syngas upstream of this operation, in the case obtaining purified hydrogen as a renewable syngas separation product (e.g., by utilizing one or more PSA and/or membrane separation stages).

Independently of, or in combination with, the representative amounts (concentrations) of H₂ and CO above, the gasifier effluent may comprise CO₂, for example in an amount of at least about 2 mol-% (e.g., from about 2 mol-% to about 30 mol-%), at least about 5 mol-% (e.g., from about 5 mol-% to about 25 mol-%), or at least about 10 mol-% (e.g., from about 10 mol-% to about 20 mol-%). Independently of, or in combination with, the representative amounts (concentrations) of H₂, CO, and CO₂ above, the gasifier effluent may comprise CH₄, for example in an amount of at least about 0.5 mol-% (e.g., from about 0.5 mol-% to about 15 mol-%), at least about 1 mol-% (e.g., from about 1 mol-% to about 10 mol-%), or at least about 2 mol-% (e.g., from about 2 mol-% to about 8 mol-%). Together with any water vapor (H₂O), these non-condensable gases H₂, CO, CO₂, and CH₄ may account for substantially all of the composition of the gasifier effluent. That is, these non-condensable gases and any water may be present in the gasifier effluent in a combined amount of at least about 90 mol-%, at least about 95 mol-%, or even at least about 99 mol-%.

### Tar Removal Operation

The raw gasifier effluent, obtained directly from the gasifier, will generally comprise gasifier effluent tar, such that a tar removal operation is typically necessary for further processing. This gasifier effluent tar can include compounds that are referred to in the art as “tars” and “oils” and are more particularly hydrocarbons and oxygenated hydrocarbons having molecular weights greater than that of methane, which may be present in the gasifier effluent at concentrations ranging from several wt-ppm to several wt-%. Certain types of these compounds, having relatively high molecular weight, are further characterized by being problematic due to their tendency to condense at lower temperatures and coat internal surfaces of processing equipment, downstream of the gasifier, causing undesirable fouling, corrosion, and/or plugging. These compounds also interfere with subsequent processing steps, or syngas conversion operations, for upgrading synthesis gas to higher value products, which perform optimally (e.g., from the standpoint of stability) with pure feed gases.

Particular compounds that are undesirable for these reasons include hydrocarbons and oxygenated hydrocarbons having six carbon atoms or more (C₆⁺ hydrocarbons and oxygenated hydrocarbons), with benzene, toluene, xylenes, naphthalene, pyrene, phenol, and cresols being specific examples. These compounds are typically present in the raw gasifier effluent in a total (combined) amount from 1-100 g/Nm³. The removal (e.g., by conversion) of these organic compounds is therefore generally necessary to avoid serious problems caused by their deposition over time. Other types of tars and oils, such as ethane, ethylene, and acetylene, will not condense from the gasifier effluent but will nonetheless “tie up” hydrogen and carbon, with the effect of reducing the overall yield of H₂ and CO as the desired components of synthesis gas.

Depending on the specific tar removal operation, tars and oils in the raw gasifier effluent can be converted, either catalytically or non-catalytically, by oxidation, cracking, and/or reforming to provide, in the tar-depleted gasifier effluent, additional H₂ and CO. The tar conversion reaction(s) can utilize available O₂ or oxygen sources (e.g., H₂O and/or CO₂) that are present in, and/or added to, the synthesis gas. In view of the gasifier effluent tar, together with methane, containing a significant portion of the energy of the raw gasifier effluent, the conversion of these compounds can increase the overall yield of synthesis gas substantially. The tar removal operation, which may therefore, according to certain embodiments, be more specifically a tar conversion operation, can effectively reduce the concentration of compounds present as tar in the raw gasifier effluent, having been produced in the gasifier. In general, tar removal, and more particularly tar conversion reactions, may be performed under higher temperatures compared to those used in the gasifier, such that the tar-depleted gasifier effluent, obtained directly from the tar removal operation, may have a temperature of greater than about 1000 °C (e.g., from about 1000 °C (1832 °F) to about 1500 °C (2732 °F), such as from about 1204 °C (2200 °F) to about 1427 °C (2600 °F)).

According to one embodiment, the tar removal operation may be used for the conversion (e.g., reforming) of tar and methane through non-catalytic partial oxidation (Pox) in a reactor used for this operation. The efficiency of this specific operation can be promoted using hot oxygen burner (HOB) technology, according to which an excess of oxygen is mixed with a small amount of fuel (e.g., natural gas, propane, or recycled synthesis gas). Combustion of this fuel within the reactor can result in a temperature increase to above 1100 °C (2012 °F), causing the combustion products and excess oxygen to accelerate to sonic velocity through a nozzle, thereby forming a turbulent jet that enhances mixing between the tar/methane containing synthesis gas and the reactive hot oxygen stream. An HOB-based system can effectively improve synthesis gas yields.

In the case of a tar removal operation that utilizes catalytic conversion of tar and methane, this operation may include a reactor containing a bed of catalyst comprising solid or supported Ni, solid or supported Fe, and/or dolomite, for example in the form of a secondary fluidized bed downstream of the gasifier. Other catalysts for tar conversion include olivine, limestone, zeolites, and even metal-containing char produced from the gasification. As in the case of non-catalytic processes that may be performed in a tar removal operation, catalytic tar conversion may likewise include the introduction of supplemental oxygen and/or steam reactants, into a reactor used for this operation.

According to other particular embodiments, the tar removal operation may utilize a suitable liquid or solid adsorbent, to selectively adsorb tars and oils from the raw gasifier effluent. For example, the tar removal operation may be performed with an oil washing system, whereby the raw gasifier effluent is passed through (contacted with) a liquid medium such as bio-oil liquor, to extract the tars and oils based on their preferential solubility. The liquid adsorbent may be combusted after it has become spent.

Regardless of the particular method by which the tar removal operation is performed, the raw gasifier effluent may comprise tars and oils (e.g., present as compounds described above) in an amount, or combined amount, from about 0.01 wt-% to about 5 wt-%, such as from about 0.1 wt-% to about 3 wt-% or from about 0.5 wt-% to about 2 wt-%. The tar removal operation may be effective to substantially or completely remove this gasifier effluent tar. For example, the tar-depleted gasifier effluent exiting, or obtained directly from, this operation, may comprise tars and oils in an amount, or combined amount, of less than about 0.5 wt-%, less than about 0.1 wt-%, or less than about 0.01 wt-%. Representative levels of removal of tars and oils (e.g., by conversion), measured across the tar removal operation, may be at least about 90%, at least about 95%, or even at least about 99%, resulting in a tar-depleted gasifier effluent that may be substantially or completely free of tar.

### Quenching Operation

Hot gasifier effluent, for example the tar-depleted gasifier effluent exiting the tar removal operation, can be cooled by various techniques that include radiant and/or convective heat exchange. In representative embodiments, at least one quenching operation, and preferably a dry quenching operation, is used, in which water is added directly to the gasifier effluent and contributes to its overall moisture content, thereby favoring H₂ production via the equilibrium-limited WGS reaction (i.e., to provide an increased H₂:CO molar ratio and an increased H₂ concentration). A dry quenching operation utilizes the sensible heat of the gasifier effluent to vaporize the injected water, which is sufficient for obtaining the resulting quenched gasifier effluent at a desired, cooler temperature. In the case of using dry quenching without the further use of an RSC or a CSC, the quenched gasifier effluent may have a temperature from about 400 °C (752 °F) to about 900 °C (1652 °F), and preferably from about 538 °C (1000 °F) to about 816 °C (1500 °F) to allow for further processing. After cooling by quenching alone or optionally after sufficient further cooling (e.g., using an RSC or CSC) a subsequent filtration operation (passage through a filter) may be performed on the gasifier effluent to remove solid particles (e.g., dust). In preferred embodiments, only a partial quench is used in the quenching operation, as opposed to a full quench, such that the quenched gasifier effluent exiting, or obtained directly from, the dry quenching operation is above its dewpoint, i.e., not saturated. In general, the dry quenching operation can promote rapid and efficient cooling through direct contact between hot gasifier effluent and water or other aqueous quenching medium.

### Radiant Syngas Cooler (RSC) or Convective Syngas Cooler (CSC)

As described herein, according to preferred embodiments, a combination of a quenching operation characterized by direct contact of a synthesis gas (e.g., the tar-depleted gasifier effluent exiting the tar removal operation) and a quenching medium such as water, together with an RSC or a CSC, can provide effective cooling for further downstream operations. An RSC, if used, may be particularly effective for the removal of ash and formed slag. An RSC or CSC may be used to cool a quenched gasifier effluent exiting the quenching operation to provide a cooled gasifier effluent, with the quenched gasifier effluent optionally having a temperature within a range as described above and/or the cooled gasifier effluent having temperature from about 250 °C (482 °F) to about 600 °C (1112 °F), and preferably from about 275 °C (527 °F) to about 450 °C (842 °F) to allow for subsequent filtration. In some embodiments, an RSC or CSC may be used to achieve such temperatures of a cooled gasifier effluent, in the absence of a quenching operation. In any event, an RSC or CSC may operate by indirect heat transfer, such as in the case of having a shell and tube configuration, typically with the generation of steam. Accordingly, this steam serves as a hot fluid, in embodiments described herein, into which heat from an operation, namely the RSC or CSC, is recovered. This heat generally originates completely or substantially from the upstream gasifier and/or tar removal operations. According to more particular embodiments, an RSC or a CSC may operate as a boiler (e.g., a fire tube boiler or water tube boiler) for the production of steam, such as medium and/or high pressure steam, as a hot fluid described herein.

### Filtration Operation

A filtration operation, using any suitable filter, may be used to remove solid particles (particulates) from the gasifier effluent, for example the cooled gasifier effluent as described above, exiting an RSC or CSC. In the case of biomass gasification, these solid particles can include char, tar, soot, and ash, any of which can generally contain alkali metals such as sodium. Corrosive and/or harmful species such as chlorides, arsenic, and/or mercury may also be contained in such solid particles. A high temperature filtration, for example using bundles of metal or ceramic filters, may generally be sufficient to reduce the content of solid particles in the gasifier effluent, such as to provide a filtered gasifier effluent exiting, or obtained directly from, the filtration operation and having less than 1 wt-ppm, and possibly less than 0.1 wt-ppm of solid particles. In representative embodiments, the filtered gasifier effluent may have a temperature in a range as described above with respect to the cooled gasifier effluent.

In some embodiments, a filtration operation may be performed upstream of (prior to) the tar removal operation to allow the latter to operate more effectively. The removal of solid particles of varying average particles sizes, using filtration or other techniques, may be performed at any of a number of possible stages within the overall process. For example, coarse solids removal by centrifugation may be performed directly downstream of the gasifier, and/or may even be performed in situ in the gasifier (e.g., using internal cyclones, for removal of solid particles, positioned in a headspace above a fluidized particle bed).

The filtration operation may be followed by, or integrated with, a supplemental cleaning operation to further purify the gasifier effluent, such as to further reduce its tar and overall hydrocarbon content, for example by contact with a solid “polishing” material such as a carbon bed. This can provide for more thorough removal of benzene, naphthalene, pyrene, toluene, phenols, and other condensable species that could otherwise be detrimental to downstream operations, such as by deposition onto equipment.

### Heat Transfer

As noted above with respect to the operations of an RSC or a CSC that can generate steam as a hot fluid into which heat from these operations may be recovered, a hot fluid such as steam may be generated from the gasifier effluent, when subjected to other operations. For example, even downstream of an RSC or a CSC, significant heat can remain present in a gasifier effluent, such as the filtered gasifier effluent described above and exiting, or obtained directly from, the filtration operation. According to some embodiments, a heat exchanger such as boiler may be used (e.g., a kettle boiler or other equipment that utilizes convective heat exchange) as a scrubber feed cooler, to carry out indirect heat exchange for recovery of heat from the scrubbing operation into a hot fluid, such as scrubber-generated steam. For example, the scrubber feed cooler, as a boiler or other heat exchanger, may more specifically perform cooling of a heated scrubber feed to provide the scrubber feed (or cooled scrubber feed) that is input directly into the scrubber, in which case both the heated and cooled streams may comprise an un-scrubbed gasifier effluent, such as the filtered gasifier effluent. This cooling may be accompanied by heating boiler feed water or other hot fluid used for recovery of heat from the scrubbing operation, and more specifically the scrubber feed cooler. The scrubbing operation may therefore include, in particular embodiments, the production of scrubber-generated steam, using a scrubber feed cooler immediately upstream of the scrubbing operation. In specific embodiments, the “heated scrubber feed” may correspond to, or may comprise, the “filtered gasifier effluent.” Also, the heated scrubber feed/filtered gasifier effluent and the scrubber feed/cooled scrubber feed may be specific examples of an “un-scrubbed gasifier effluent.”

As in the case of RSC-generated steam or CSC-generated steam, the scrubber-generated steam, into which heat from the scrubbing operation is recovered, may be integrated within the overall process, for example used for applications such as heating and/or drying, according to uses generally for hot fluids into which heat is recovered from a first operation (e.g., the RSC or CSC) as described herein. Representative heating and/or drying operations include drying of the carbonaceous feed (e.g., biomass) and the WGS operation, either or both of which may be performed by utilizing at least a portion of heat that is transferred from a hot fluid to an intermediary fluid as described herein. In representative embodiments, the heated intermediary fluid may be provided to a heat input of a dryer and/or to a heat input to the WGS operation, with representative heat inputs being heat exchangers of these respective operations. For example, the heated intermediary fluid may be provided to a heat input of a WGS feed heater immediately upstream of the WGS operation, in order to utilize heat, transferred to the intermediary fluid from the hot fluid, in this second operation. Alternatively, or in combination, a heated intermediary fluid may be provided to a heat input of a dryer for drying of the carbonaceous feed (e.g., a biomass dryer), such that heat transferred to this fluid, from a hot fluid into which heat from a first operation (e.g., an RSC or CSC, and/or a scrubber feed cooler) is recovered, may be utilized in this second operation.

Immediately upstream of a scrubber feed cooler, which may operate as a boiler for steam generation or as another type of heat exchanger, the heated scrubber feed, such as the filtered gasifier effluent, may have a temperature within the ranges given above with respect to this stream, for example a temperature corresponding to that of the cooled gasifier effluent, which may be from about 250 °C (482 °F) to about 600 °C (1112 °F), and preferably from about 275 °C (527 °F) to about 450 °C (842 °F). In representative embodiments, the scrubber feed, as a consequence of recovering a portion of its heat into a hot fluid, such as by producing scrubber-generated steam using a scrubber feed cooler, may be cooled from a temperature within a range as described above to a temperature from about 100 °C (212 °F) to about 225 °C (437 °F), and preferably from about 105 °C (221 °F) to about 185 °C (365 °F). Such temperature may correspond to the scrubber gas inlet temperature or scrubber operating temperature.

### Scrubbing Operation

A scrubbing operation may be used to remove water and water-soluble contaminants from an un-scrubbed gasifier effluent, such as the filtered gasifier effluent exiting the filtration operation, and optionally following the cooling of this stream by steam generation. For example, the filtered gasifier effluent may serve as a feed to a scrubber feed cooler, operating as a boiler or other type of heat exchanger that, following indirect heat exchange, provides a cooled effluent upstream of the scrubbing operation. All or at least a portion of this effluent may provide the scrubber feed to the scrubbing operation. The temperature of this scrubber feed may be controlled through varying of the amount of heat removed by the scrubber feed cooler and thereby recovered from the scrubbing operation into a hot fluid such as steam. The scrubbing operation itself may provide further cooling of the scrubber feed. For example, the scrubber feed entering the scrubber following cooling (e.g., and providing scrubber-generated steam) as described above, may have a temperature as also described above, which corresponds to the scrubber gas inlet temperature. The scrubbed gasifier effluent exiting the scrubber may have a temperature from about 35 °C (95 °F) to about 100 °C (212 °F), and preferably from about 38 °C (100 °F) to about 66 °C (150 °F).

The scrubbing operation, such as wet scrubbing, may be effective for removing, as water-soluble contaminants, chlorides (e.g., in the form of HCl), ammonia, and HCN, as well as fine solid particles (e.g., char and ash). For example, in the case of using a wet scrubber, an un-scrubbed gasifier effluent, such as the scrubber feed obtained following cooling, may be fed to a trayed column to perform co-current or counter-current contacting with water or an aqueous solution. Further cooling in this column, such as to a temperature below 100 °C (212 °F) can aid in droplet condensation for improving the contaminant removal effectiveness. The scrubbing operation can be used to provide a scrubbed gasifier effluent exiting, or obtained directly from, this operation and having a combined amount of chloride, ammonia, and solid particles of less than 1 wt-ppm, and possibly less than 0.1 wt-ppm. The scrubbing operation also generally serves to remove water, such that the moisture content of the scrubbed gasifier effluent is reduced, relative to that of the scrubber feed.

### WGS Operation

The water gas shift (WGS) operation reacts CO present in a gasifier effluent, for example the scrubbed gasifier effluent immediately exiting the scrubbing operation, with steam to increase H₂ concentration (as well as CO₂ concentration). In this manner, the scrubbed gasifier effluent may be characterized as a feed to the WGS operation (WGS feed). Following the tar removal operation, filtration operation, and scrubbing operation, the scrubbed gasifier effluent/feed to the WGS operation may have favorable properties for use in this operation, in terms of its being free or substantially free of water-soluble contaminants as described above, as well as tars and particulates.

According to some embodiments, the scrubbed gasifier effluent/feed to the WGS operation may be heated and/or supplemented with moisture (steam) to further improve its properties for kinetically and/or thermodynamically favoring the WGS reaction that desirably increases the H₂:CO molar ratio and/or H₂ concentration of the WGS product relative these characteristics of the WGS feed. For example, a WGS feed heater may be used to heat this feed to a temperature from about 225 °C (437 °F) to about 475 °C (887 °F), and preferably from about 260 °C (500 °F) to about 399 °C (750 °F), prior to its input to the WGS operation. A heated intermediary fluid may be provided to an input to the WGS feed heater, such that heat transferred to this fluid, from a hot fluid into which heat from a first operation (e.g., an RSC or CSC, and/or a scrubber feed cooler) is recovered, may be utilized in the WGS operation, as a second operation.

The moisture content of this feed may be augmented by direct utilization of a supplemental source of steam, such as at least a portion of the RSC-generated steam or CSC-generated steam, and/or the scrubber-generated steam as described herein (e.g., generated using a boiler). For example, at least a portion of such generated steam (e.g., low or medium pressure steam), which may also serve as a hot fluid described herein, may be fed or added directly to the WGS operation (e.g., combined with the WGS feed or added directly to one or more reactors used in the WGS operation). Therefore, such generated steam may be used as a feed to this operation itself and not merely for heat-exchanging contact with such feed, in order to improve overall heat balancing/integration. In the WGS operation, the direct use of steam in excess of the stoichiometric amount may be beneficial, particularly in adiabatic, fixed-bed reactors, for a number of purposes. These include driving the equilibrium toward hydrogen production, adding heat capacity to limit the exothermic temperature rise, and minimizing side reactions, such as methanation.

Reactors used in a WGS operation may contain a suitable catalyst, such as those comprising one or more of Co, Ni, Mo, and W on a solid support, particular examples of which are Co/Mo and Ni/Mo catalysts that exhibit sulfur tolerance. Other catalysts for use in this operation (i.e., contained within one or more WGS reactors) include those based on copper-containing and/or zinc-containing catalysts, such as Cu—Zn—Al; chromium-containing catalysts; iron oxides; zinc ferrite; magnetite; chromium oxides; and any combination thereof (e.g., Fe₂O₃ —Cr₂O₃ catalysts).

In a typical WGS operation, two or more reactors with interstage cooling may be used in view of the thermodynamic characteristics of the WGS reaction. For example, a high-temperature shift (HTS) reactor may operate with a temperature of the reactor inlet from about 310 °C (590 °F) to about 450 °C (842 °F), with more favorable reaction kinetics but a less favorable equilibrium conversion. The effluent from the HTS may then be cooled to a temperature suitable for the reactor inlet of a low-temperature shift (LTS) reactor, such as from about 200 °C (392 °F) to about 250 °C (482 °F), for providing less favorable reaction kinetics but a more favorable equilibrium conversion, such that the combined effect of the HTS and LTS reactors results in a high conversion to H₂ with a favorable residence time. In some cases, it may be desirable to use three or more reactors, or catalyst beds, to perform the WGS reaction, again with cooling between consecutive reactors or catalyst beds.

In this manner, the WGS operation may be used to provide an immediate WGS product exiting, or obtained directly from, this operation and having an increased H₂:CO molar ratio and increased H₂ concentration, relative to the feed to the WGS operation or the synthesis gas obtained from upstream operations (e.g., filtered gasifier effluent or cooled gasifier effluent). For example, the immediate WGS product may have an H₂:CO molar ratio from about 0.5 to about 3.5, from about 1.0 to about 3.0, or from about 1.5 to about 2.5 and/or a hydrogen concentration of at least about 35 mol-% (e.g., from about 35 mol-% to about 80 mol-%), at least about 40 mol-% (e.g., from about 40 mol-% to about 70 mol-%), or at least about 45 mol-% (e.g., from about 45 mol-% to about 65 mol-%). These characteristics of the immediate WGS product may be controlled by bypassing the WGS operation to a greater or lesser extent (e.g., diverting a smaller or larger portion of the feed to this operation, around this operation to provide a portion of the immediate WGS product). The WGS operation may be further beneficial in terms of converting carbonyl sulfide (COS) to H₂S which can be recycled and more easily removed elsewhere in the process, such as in an acid gas removal operation or possibly, at least to some extent, in the scrubbing operation.

### Syngas Conversion or Separation Operations

In some embodiments, processes described herein may also include a syngas conversion operation or syngas separation operation to produce a respective renewable syngas conversion product or renewable syngas separation product, such as liquid hydrocarbons, methanol, or RNG as examples of conversion products, and purified hydrogen as an example of a separation product. In the case of liquid hydrocarbon production, the syngas conversion operation may comprise a Fischer-Tropsch (FT) reaction stage. One or more reactors in this stage are used to process the synthesis gas mixture of hydrogen (H₂) and carbon monoxide (CO) by successive cleavage of C—O bonds and formation of C—C bonds with the incorporation of hydrogen. This mechanism provides for the formation of hydrocarbons, and particularly straight-chain alkanes, with a distribution of molecular weights that can be controlled to some extent by varying the FT reaction conditions and catalyst properties. Such properties include pore size and other characteristics of the support material. The choice of FT catalyst and its active metals (e.g., Fe or Ru) can impact FT product yields in other respects, such as in the production of oxygenates.

In the case of methanol production, the syngas conversion operation may comprise a methanol synthesis reaction stage. One or more reactors in this stage are used to form methanol according to the catalytic reaction:

CO+2H₂→CH₃OH (1)

Representative catalysts for the synthesis of methanol by this route are characterized by “CZA,” which is a reference to copper and zinc on alumina, or Cu/ZnO/Al₂O₃. Alternatively, or in combination, various other catalytic metals and their oxides may be used, including one or more of W, Zr, In, Pd, Ti, Co, Ga, Ni, Ce, Au, Mn, and their combinations.

In the case of methane production as a syngas conversion operation to provide a renewable natural gas (RNG) product, one or more methanation reactors (e.g., in series or parallel) may be used to react CO and/or CO₂ with hydrogen and thereby provide a hot methanation product having a significantly higher concentration of methane relative to that initially present (e.g., in the WGS product). Catalysts suitable for use in a methanation reactor include supported metals such as ruthenium and/or other noble metals, as well as molybdenum and tungsten. Generally, however, supported nickel catalysts are most cost effective. Often, a methanation reactor is operated using a fixed bed of the catalyst.

In the case of purified hydrogen production, the syngas separation operation may comprise a renewable hydrogen separation stage that can utilize, for example, (i) an adsorbent in the case of separation by PSA or (ii) a membrane. Combinations of such stages may be used in a given syngas separation operation. In any such operation, a gaseous separation byproduct is also provided that is generally enriched in the non-hydrogen components of syngas, such as CO, CO₂, and/or H₂O. This byproduct may be, for example, a PSA tail gas or otherwise a membrane permeate or retentate, depending on the particular membrane used and consequently whether the renewable hydrogen separation product is recovered as the membrane retentate or permeate. This hydrogen, obtained as a result of utilizing a syngas separation operation downstream of the WGS operation, may, in some embodiments, be characterized as high purity hydrogen (e.g., having a purity of at least about 99 mol-% or more, such as at least 99.9 mol-% or at least 99.99 mol-%).

### Further Exemplary Embodiments of Gasification Processes

FIG. 1 depicts a flowscheme illustrating the use of an intermediary fluid for transferring heat from a first operation to a second operation. According to embodiments shown, hot fluid 110 is used for recovery of a first amount of heat from a first operation, which may be a heat exchanger alone or a heat exchanger (e.g., a cooler) associated with the first operation (e.g., directly upstream or directly downstream of the first operation). For example, with reference to FIG. 2, the hot fluid may be RSC-generated steam or CSC-generated steam 23, or may be scrubber-generated steam 34. Accordingly, the first operation may be an RSC; a CSC; or a scrubber, optionally with an associated scrubber feed cooler. Whereas hot fluid 110 contains the recovered, first amount of heat, a second amount of heat, which may be all or a portion of this first amount of heat, is transferred from hot fluid 110 to all or at least a portion of intermediary fluid 100, such as through the use of intermediary fluid heater 150a, thereby providing all or at least a portion of heated intermediary fluid 115. In this manner, the second amount of heat is transferred into heated intermediary fluid 115, and at least a portion of this second amount of heat is utilized (or consumed) in second operation 175, such as by being fed to this operation or to a heat exchanger (e.g., a heater) associated with the second operation (e.g., directly upstream or directly downstream of the second operation). For example, with reference to FIG. 2, the second operation may be dryer 45 or may be WGS operation 90, with heated intermediary fluid being fed to dryer input 31 or to heat input 35 to WGS operation 90, through WGS feed heater 85 upstream of this operation.

More generally, at least a portion of the second amount of heat that is transferred to the intermediary fluid may be utilized (or consumed) for drying and/or heating requirements of the process. That is, utilizing (or consuming) at least a portion of the second amount of heat, transferred to the intermediary fluid, may comprise heating and/or drying in the second operation 175, with dryer 45 (FIG. 1) for drying carbonaceous feed 10 (FIG. 1) being a preferred example of a second operation. In any event, utilization (or consumption) of heat in the second operation 175 can result in cooling of the heated intermediary fluid, such that fluid after the second operation 175, for example recycled intermediary fluid 120 as shown in FIG. 1, may have a cooler temperature. In representative embodiments, such as in the case of second operation 175 being dryer 45 or other embodiments more generally, heated intermediary fluid 115 immediately upstream of, and provided to, this operation may have a temperature from about 93 °C (200 °F) to about 150 °C (302 °F), such as from about 100 °C (212 °F) to about 135 °C (275 °F). Alternatively or in combination, following cooling, recycled intermediary fluid 120 may have a temperature from about 52 °C (125 °F) to about 125 °C (257 °F), such as from about 70 °C (158 °F) to about to about 100 °C (212 °F).

As described above, particular advantages are gained from the “decoupling” of fluids obtained directly from the process and used conventionally for heat exchange, by the use of an intermediary fluid. This overcomes boundary constraints between operations, relating to (i) mis-matched fluid compositions and/or pressures, which can become problematic in the event of leakage, (ii) mis-matched minimum and/or maximum heat requirements and corresponding process flows, as well as (iii) other incompatibilities due to constraints of the available, heat-transferring process fluid. Benefits reside, for example, in embodiments in which the hot fluid, into which the first amount of heat is recovered from the first operation of the process, comprises one or more unsafe and/or corrosive constituents that might otherwise pose a hazard from direct ingress into the second operation in the event of a leak. Exemplary constituents that are often encountered in hot fluids (e.g., scrubber water or scrubber-generated steam) include CO, CO₂, N₂, NH₃, HCl, HCN, CH₄, and combinations of these. Benefits likewise reside in embodiments in which the pressure of the second operation is lower than the pressure of the first operation, in which case heat transfer may be, but is not necessarily, from an upstream operation to a downstream operation.

As further illustrated in FIG. 1, the second amount of heat, transferred to intermediary fluid 100 for utilization (consumption) of at least a portion thereof in second operation 175, may be controlled based on a heat input requirement of this operation. More particularly, the second amount of heat and its transfer from hot fluid 110 of the first operation may be controlled through controlling a temperature (TT) of heated intermediary fluid 115, with a higher or lower setpoint temperature governing a corresponding, higher or lower amount of heat transfer (e.g., amount of hot fluid being input to intermediary fluid heater 150a). Also, representative processes may comprise regulating the flow rate (FT) of intermediary fluid 100, such as through variable rate pump 250, based on heat flow requirements of second operation 175, which may change as a function of time for a given second operation, or as a function of changing the type of second operation altogether (e.g., from the dryer to the WGS operation), to which heated intermediary fluid 115 is routed for utilizing heat. Alternatively to, or in combination with, regulating temperature and/or flow rate of the heated intermediary fluid, representative processes may comprise regulating the pressure of the intermediary fluid, based on pressure requirements of the second operation, which may change as a function of time for a given second operation, or as a function of changing the type of second operation altogether, as noted above. For example, pressure of intermediary fluid reservoir 200 may be conveniently regulated according to a header pressure above a liquid level in this reservoir, which header pressure may be maintained by air or an inert gas such as nitrogen.

As also illustrated in FIG. 1, according to representative embodiments, intermediary fluid 100 may circulate in a primary loop defined by, or comprising, flows of (i) intermediary fluid 100 upstream of the transferring of the second amount of heat (e.g., in the intermediary fluid heater 150a), (ii) heated intermediary fluid 115 downstream of this transferring of the second amount of heat, and (iii) recycled (e.g., cooled) intermediary fluid 120 downstream of the utilizing (e.g., consuming) of the at least portion of the second amount of heat (e.g., in second operation 175). As also shown in FIG. 1, the recycled intermediary fluid 120 may be returned to intermediary fluid reservoir 200, providing capacity of the intermediary fluid for the process, and more particularly for the circulation loop in which the intermediary fluid is utilized.

Even greater flexibility in addressing integrated heating and cooling requirements of operations of the process is afforded, according to more specific embodiments, through the implementation of further loops of the intermediary fluid, to which heat may be added or from which heat may be rejected. For example, as additionally illustrated in FIG. 1, representative processes may comprise removing (e.g., continuously or intermittently, such as periodically) secondary loop portion 100b of intermediary fluid 100 from the primary loop. In this case, a remaining primary loop portion 100a exchanges with hot fluid 110 for transfer of the second amount of heat, more specifically to primary loop heated intermediary fluid 102 that provides a portion of heated intermediary fluid 115. Cooling or heating of secondary loop portion 100b provides secondary loop cooled intermediary fluid 104 or secondary loop heated intermediary fluid 104, which may be returned to the primary loop. Following this return, the secondary loop cooled intermediary fluid 104 or secondary loop heated intermediary fluid 104 may respectively decrease, or increase, the temperature of heated intermediary fluid 115 as needed for utilization of its heat in a given, second operation 175. Intermediary fluid of a secondary loop may be removed from and added to the primary loop at various locations about the primary loop to achieve desired heat transfer characteristics. According to the specific embodiment illustrated in FIG. 1, secondary loop portion 100b of intermediary fluid 100 is removed from the primary loop, as defined above, upstream of the transferring of the second amount of heat (e.g., in the intermediary fluid heater 150a) and returned to the primary loop upstream of the utilizing of the at least portion of the second amount of heat (e.g., in second operation 175).

Advantageously, heat may be added to or rejected from a further loop, such as a secondary loop, by heat exchange with (i) streams and/or products of the gasification process, and/or with (ii) external or auxiliary streams and/or products. For example, according to specific embodiments, cooling or heating secondary loop portion 100b may be performed by exchanging heat between a secondary fluid, from which heat from a third operation of the process has been utilized (e.g., consumed) or into which heat from the third operation of the process has been recovered, and secondary loop portion 100b of intermediary fluid 100. In more specific embodiments, such cooling or heating secondary loop portion 100b may be performed by this exchanging of heat between a secondary fluid of the process and secondary loop portion 100b of intermediary fluid 100, in combination with auxiliary cooling or heating of secondary loop portion 100b of intermediary fluid 100. In this regard, FIG. 1 illustrates a particular embodiment according to which secondary loop portion 100b may be cooled, in this case to provide secondary loop cooled intermediary fluid 104, namely by this exchanging of heat between a secondary fluid of the process (e.g., from which, or into which, heat from a third operation of the process has been utilized, or recovered), as performed by intermediary fluid cooler 150b, in combination with auxiliary cooling, as performed by auxiliary cooler 125, such as a fan cooler.

FIG. 2 depicts a flowscheme that is representative of gasification processes, including various operations, from which a first amount of heat may be recovered into a hot fluid (e.g., steam), or in which at least a portion of a second amount of heat may be utilized (e.g., by a heated intermediary fluid being provided/fed to an input to that operation). With reference to this figure, and with the understanding that embodiments disclosed herein do not necessarily require all of the illustrated features, such embodiments may be directed to a process for gasification of a carbonaceous feed (e.g., wood) generally. The process may comprise, in gasifier 50, contacting carbonaceous feed 10 (or dried carbonaceous feed 10a, following dryer 45) with oxygen-containing gasifier feed 14 (and optionally a separate source of steam) under gasification conditions to provide a gasifier effluent comprising H₂, CO, CO₂, and H₂O. Oxygen-containing gasifier feed 14 alone (or possibly in combination with a separate source of steam), may comprise H₂O and O₂, as well as optionally CO₂, in a combined concentration of at least about 90 mol-%, at least about 95 mol-%, or at least about 99 mol-%. The gasifier effluent may be any process stream, other than those non-syngas-containing process streams used for heat exchange that enter and exit coolers and heaters (e.g., boiler feed water and steam), and other than the intermediary fluid. The un-scrubbed gasifier effluent may be, more particularly, any of these gasifier effluent process streams downstream of gasifier 50 and upstream of scrubbing operation 80, including raw gasifier effluent 16, tar-depleted gasifier effluent 18, quenched gasifier effluent 22, cooled gasifier effluent 24, filtered gasifier effluent 26, or scrubber feed 28.

The process may comprise feeding at least a portion of the un-scrubbed gasifier effluent, for example as scrubber feed 28, to scrubbing operation 80 to remove at least a portion of the water-soluble contaminants and provide scrubbed gasifier effluent 30. Further upstream of scrubbing operation 80, an un-scrubbed gasifier effluent or portion thereof may be fed, for example as heated scrubber feed 26, to scrubber feed cooler 75 for steam generation from heat in this heated scrubber feed, and for providing scrubber feed 28 (which may also be referred to as a cooled scrubber feed). The scrubbing operation 80 and its associated scrubber feed cooler 75 can provide scrubber feed 28, as a syngas-containing process stream, as well as scrubber-generated steam 34 as a non-syngas-containing process stream. More specifically, scrubber-generated steam 34 may result from heat exchange between heated scrubber feed 26 and scrubber feed cooler boiler feed water 32. It can therefore be appreciated that either or both of heated scrubber feed 26 and scrubber feed 28 may correspond to, or may comprise, an un-scrubbed gasifier effluent, such as in the particular case of an un-scrubbed gasifier effluent, that, as a heated scrubber feed, is at a higher temperature relative to this un-scrubbed gasifier effluent, as a scrubber feed. The un-scrubbed gasifier effluent, as heated scrubber feed 26 and scrubber feed 28, may have the same composition. In exemplary embodiments, the un-scrubbed gasifier effluent, which is fed to scrubber feed cooler 75 as heated scrubber feed 26, may be a filtered gasifier effluent, having been subjected to filtration operation 70 to remove solid particles. More particularly, in addition to having been subjected to filtration operation 70, the filtered gasifier effluent may have been further subjected to one or more intervening operations downstream of gasifier 50 and upstream of filtration operation 70. For example, such intervening operations may include one or more of (i) tar removal operation 55 to remove at least a portion of gasifier effluent tar (e.g., and provide tar-depleted gasifier effluent 18), (ii) quenching operation 60 comprising direct contact with quench water 20 (e.g., and provide quenched gasifier effluent 22), and (iii) radiant syngas cooler 65 (RSC) or convective syngas cooler (CSC) 65 implementing heat-exchanging contact with RSC feed water 25 or CSC feed water 25. The operation of RSC or CSC can provide cooled gasifier effluent 24, as a syngas-containing process stream, as well as RSC-generated steam 23 or CSC-generated steam 23, as a non-syngas-containing process stream.

According to a representative process, raw gasifier effluent 16 produced in gasifier 50 is fed to tar removal operation 55, to provide tar-depleted gasifier effluent 18, having a lower amount of tar relative to raw gasifier effluent 16. Generally, processes comprise recovering a synthesis gas product from tar-depleted gasifier effluent 16, with such synthesis gas product possibly including any of those syngas-containing process streams downstream of tar-depleted gasifier effluent 16, as illustrated in the FIG. 2. For example, the synthesis gas product may be recovered as water-gas shift (WGS) product 36 of WGS operation 90, optionally following one or more intervening operations performed on the gasifier effluent, downstream of the tar removal operation and upstream of the WGS operation. Such intervening operations can include one or more of (i) quenching operation 60 comprising direct contact of the gasifier effluent with quench water 20, (ii) radiant syngas cooler (RSC) 65 or convective syngas cooler (CSC) 65, implementing heat-exchanging contact of the gasifier effluent with RSC boiler feed water 25 or CSC boiler feed water 25, (iii) filtration operation 70 to remove solid particles from the gasifier effluent, (iv) scrubber feed cooler 75 to further remove heat from the gasifier effluent and control the temperature of the downstream scrubbing operation, (v) scrubbing operation 80 to remove water-soluble contaminants from the gasifier effluent, and (vi) WGS feed heater 85, implementing heat-exchanging contact of the scrubbed gasifier effluent with heat input 35 to WGS operation 90 to provide WGS feed 33 having a higher temperature, relative to scrubbed gasifier effluent 30, that is more suitable for effective performance of the WGS operation.

As more particularly illustrated in FIG. 2, a representative process comprises, in quenching operation 60, which may be more particularly a partial dry quench (PDQ) operation, contacting (e.g., by direct contact), tar-depleted gasifier effluent 18 with quench water 20. This provides quenched gasifier effluent 22, having a temperature that is decreased relative to that of tar-depleted gasifier effluent 18. The process may additionally comprise, in radiant syngas cooler (RSC) 65 or convective syngas cooler (CSC) 65, further cooling quenched gasifier effluent 22, such as by indirect, heat-exchanging contact with RSC boiler feed water 25 or CSC boiler feed water 25. This provides cooled gasifier effluent 24, which may then be subjected to filtration operation 70, heat removal in scrubber feed cooler 75, and scrubbing operation 80. Feeding at least a portion of scrubbed gasifier effluent 30, provided from scrubbing operation 80, to WGS operation 90, optionally via heating in WGS feed heater 85, provides WGS product 36 having a H₂:CO molar ratio that is increased relative to that of raw gasifier effluent 16, and/or syngas exiting any of intervening operations, such as tar-depleted gasifier effluent 18, quenched gasifier effluent 22, cooled gasifier effluent 24, filtered gasifier effluent 26 exiting filtration operation 70, scrubber feed 28 to scrubbing operation 80, or scrubbed gasifier effluent 30 exiting scrubbing operation 80.

Representative processes may further comprise feeding at least a portion of WGS product 36 to syngas conversion operation 95 or syngas separation operation 95 to provide respective renewable syngas conversion product 40 or renewable syngas separation product 40. According to more specific embodiments, for example, (i) syngas conversion operation 95 may comprise a Fischer-Tropsch reaction stage, such that renewable syngas conversion product 40 comprises liquid hydrocarbons and/or oxygenates (e.g., alcohols) of varying carbon numbers, (ii) syngas conversion operation 95 may comprise a catalytic methanol synthesis reaction stage, such that renewable syngas conversion product 40 comprises methanol, or (iii) syngas conversion operation 95 may comprise a catalytic methanation reaction stage, such that renewable syngas conversion product 40 comprises RNG. According to other more specific embodiments, syngas separation operation 95 may comprise a renewable hydrogen separation stage, such that renewable syngas separation product 40 comprises purified hydrogen.

As described herein, according to representative processes, heat recovered from a first operation of the process into a hot fluid is utilized in a second operation of the process, by transfer of this heat, from the first operation to the second operation, through an intermediary fluid. With reference to FIGS. 1 and 2, it can be appreciated that, in specific embodiments, the hot fluid may be one of (i) RSC-generated steam 23, in which heat is recovered from the RSC 65 as the first operation of the process (ii) CSC-generated steam 23, in which heat is recovered from the CSC 65 as the first operation of the process, and (iii) scrubber-generated steam 34 produced in scrubber feed cooler 75, in which heat is recovered from scrubbing operation 80 as the first operation of the process. Alternatively or in combination, the second operation may be one of (i) dryer 45 for drying of carbonaceous feed 10 and (ii) WGS operation 90. For example, heat transfer may be performed through the intermediary fluid being provided to heat input 31 of dryer 45, or to heat input 35 of WGS operation 90, via WGS feed heater 85. Heaters and coolers described herein, which include dryer 45, RSC 65 or CSC 65, scrubber feed cooler 75, and WGS feed heater 85, may be implemented as any suitable heat exchanger (e.g., a shell and tube heat exchanger). In more specific embodiments, heaters described herein may be implemented as boilers.

Overall, aspects of the invention relate to gasification processes with heat transfer being performed between two operations, or among three or more operations. Utilizing an intermediary fluid for such heat transfer can improve safety, reduce exchange fluid constraints (e.g., temperatures, pressures, and flow rates) associated with operational interfaces, and provide flexible and simplified heat integration strategies that are adaptable to a number of specific process configurations. Those skilled in the art, having knowledge of the present disclosure, will recognize that various changes can be made to these processes in attaining these and other advantages, without departing from the scope of the present disclosure. As such, it should be understood that the features of the disclosure are susceptible to modifications and/or substitutions, and the specific embodiments illustrated and described herein are for illustrative purposes only, and not limiting of the invention as set forth in the appended claims.

1. A process for gasification of a carbonaceous feed and utilizing multiple operations including a first operation and a second operation, the process comprising:
(a) recovering a first amount of heat from the first operation of the process into a hot fluid;
(b) transferring a second amount of heat from the hot fluid to an intermediary fluid, thereby providing a heated intermediary fluid; and
(c) utilizing at least a portion of the second amount of heat, transferred in step (b) to the intermediary fluid, in the second operation.

2. The process of claim 1, wherein the utilizing step (c) comprises heating or drying in the second operation.

3. The process of claim 1, wherein the hot fluid comprises one or more unsafe and/or corrosive constituents.

4. The process of claim 3, wherein the one or more unsafe and/or corrosive constituents are selected from the group consisting of CO, CO₂, N₂, NH₃, HCl, HCN, CH₄, and combinations thereof.

5. The process of claim 1, wherein a pressure of the second operation is lower than a pressure of the first operation.

6. The process of claim 1, wherein the second amount of heat, transferred in step (b), is controlled based on a heat input requirement of the second operation.

7. The process of claim 6, wherein the second amount of heat, transferred in step (b), is controlled through controlling a temperature of the heated intermediary fluid.

8. The process of claim 1, further comprising regulating a flow rate of the intermediary fluid, based on heat flow requirements of the second operation.

9. The process of claim 1, further comprising regulating a pressure of the intermediary fluid, based on pressure requirements of the second operation.

10. The process of claim 1, wherein the intermediary fluid circulates in a primary loop, said primary loop comprising flows of (i) the intermediary fluid upstream of said transferring the second amount of heat, (ii) the heated intermediary fluid downstream of said transferring the second amount of heat, and (iii) a recycled intermediary fluid downstream of said utilizing at least a portion of the second amount of heat.

11. The process of claim 10, further comprising removing a secondary loop portion of the intermediary fluid from the primary loop, cooling or heating the secondary loop portion to provide a secondary loop cooled intermediary fluid or a secondary loop heated intermediary fluid, and returning the secondary loop cooled intermediary fluid or the secondary loop heated intermediary fluid to the primary loop.

12. The process of claim 11, wherein said cooling or heating the secondary loop portion is performed by exchanging heat between a secondary fluid, from which heat from a third operation of the process has been utilized or into which heat from the third operation of the process has been recovered, and the secondary loop portion of the intermediary fluid.

13. The process of claim 12, wherein said cooling or heating the secondary loop portion is performed by said exchanging heat between the secondary fluid and the secondary loop portion of the intermediary fluid, in combination with auxiliary cooling or heating of the secondary loop portion of the intermediary fluid.

14. The process of claim 13, comprising cooling the secondary loop portion to provide the secondary loop cooled intermediary fluid, by said exchanging heat in combination with said auxiliary cooling, wherein said auxiliary cooling is performed by a fan cooler.

15. The process of claim 11, wherein the secondary loop portion of the intermediary fluid is removed from the primary loop upstream of said transferring the second amount of heat and returned to the primary loop upstream of said utilizing at least a portion of the second amount of heat.

16. The process of claim 1, wherein the second operation is a dryer for drying of said carbonaceous feed.

17. The process of claim 1, wherein said heated intermediary fluid is provided to said second operation at a temperature from about 100 °C (212 °F) to about 150 °C (302 °F), and said utilizing at least a portion of the second amount of heat provides a cooled intermediary fluid at a temperature from about 70 °C (158 °F) to about 100 °C (212 °F).

18. The process of claim 1, wherein the hot fluid is steam and wherein the first operation is selected from the group consisting of a radiant syngas cooler, a convective syngas cooler, and a scrubber feed cooler.

19. A process for gasification of a carbonaceous feed, the process comprising:
in a gasifier, contacting the carbonaceous feed with an oxygen-containing gasifier feed, under gasification conditions, to provide a gasifier effluent comprising H₂, CO, CO₂, and H₂O;
in a radiant syngas cooler (RSC) or convective syngas cooler (CSC), cooling the gasifier effluent;
optionally further cooling the gasifier effluent in a scrubber feed cooler;
in a scrubbing operation, scrubbing the gasifier effluent to remove water-soluble contaminants; and
in a water-gas shift (WGS) operation, contacting the gasifier effluent with a WGS catalyst to provide a WGS product having an increased H₂:CO molar ratio,
wherein heat recovered from a first operation of the process into a hot fluid is utilized in a second operation of the process, by transfer of said heat through an intermediary fluid.

20. The process of claim 19, wherein:
said hot fluid is one of (i) RSC-generated steam, in which heat is recovered from said RSC as the first operation of the process (ii) CSC-generated steam, in which heat is recovered from said CSC as the first operation of the process, and (iii) scrubber-generated steam produced in said scrubber feed cooler, in which heat is recovered from said scrubber as the first operation of the process, and
said second operation is one of (i) a dryer for drying of said carbonaceous feed and (ii) the WGS operation.
